(19) United States
(12) Patent Application Publication
(10) Pub. No.: US 2021/0224894 A1
(43) Pub. Date: Jul. 22, 2021

(54) USER RESOURCE MANAGEMENT METHOD, APPARATUS AND DEVICE AND COMPUTER READABLE STORAGE MEDIUM

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Li SUN, Beijing (CN); Meirong ZHANG, Beijing (CN)

(21) Appl. No.: 16/760,548

(22) PCT Filed: Aug. 20, 2019
(86) PCT No.: PCT/CN2019/101470

§ 371 Date: Apr. 30, 2020

(30) Foreign Application Priority Data
Nov. 22, 2018 (CN) 201811400582.7

(51) Int. Cl. G06Q 40/02; G06Q 10/08; G06Q 50/26

(52) U.S. Cl. CPC G06Q 40/02; G06Q 50/26; G06Q 10/087; G06Q 10/0831

(57) ABSTRACT

The embodiments of this application provide a user resource management method, apparatus and device and a computer readable storage medium. The user resource management method provided by a computer executing software includes: obtaining basic information of a user resource and association information of the user resource and a first resource via a human-machine interface or a network interface; determining whether the first resource is in need of to be invoked based on the association information; invoking the first resource in response to determination of the need; and determining change of the first resource required by the user resource utilizing a rule-based engine according to at least part of the basic information, and updating the first resource using the change.

### RELATED APPLICATIONS

The present application is a 35 U.S.C. 371 national stage application of PCT International Application No. PCT/CN2019/101470, filed on Aug. 20, 2019, which claims the benefit of Chinese Patent Application No. 201811400582.7, filed on Nov. 22, 2018, the entire disclosures of which are incorporated herein by reference.

### TECHNICAL FIELD

This application relates to the field of customs affair logistics management technology, and in particular, to a user resource management method, apparatus and device and a computer readable storage medium.

### BACKGROUND

Nowadays, there is no system for specially managing customs affair logistics business (for example, mortgage guarantee business of a customs declaration form), and in the SAP (system application and products in data processing) system of a common enterprise management system, there is no component for specially managing customs affair logistics business, either, which cannot implement orderly and effective operation, deployment and update of user resources, especially customs affair resources.

### SUMMARY

For the shortcomings of the existing methods, this application proposes a user resource management method, apparatus and device and a computer readable storage medium for solving one or more of the above problems existing in the prior art.

In a first aspect, an embodiment of this application provides a user resource management method provided by a computer executing software, the method including:

obtaining basic information of a user resource and association information of the user resource and a first resource via a human-machine interface or a network interface;

determining whether the first resource is in need of to be invoked based on the association information;

invoking the first resource in response to determination of the need; and

determining change of the first resource required by the user resource utilizing a rule-based engine according to at least part of the basic information, and updating the first resource using the change.

In a second aspect, an embodiment of this application provides a user resource management apparatus including:

a data obtainer configured to obtain basic information of a user resource and association information of the user resource and a first resource via a human-machine interface or a network interface;

a condition judger configured to determine whether the first resource is in need of to be invoked based on the association information;

an invoker configured to invoke the first resource in response to determination of the need; and

an updater configured to determine change of the first resource required by the user resource utilizing a rule-based engine according to at least part of the basic information, and update the first resource using the change.

In a third aspect, an embodiment of this application provides a user resource management device including: a memory and a processor, wherein in the memory is stored a computer program which is executed by the processor to implement the user resource management method provided in the first aspect of embodiments of this application.

In a fourth aspect, an embodiment of this application provides a computer readable storage medium on which a computer program is stored, which computer program implements the user resource management method provided in the first aspect of embodiments of this application when executed by a processor.

Additional aspects and advantages of this application will be given in part in the following description, which will become clear from the following description or be learned through the practice of this application.

### BRIEF DESCRIPTION OF THE DRAWINGS

The above and/or additional aspects and advantages of this application will become clear and easily understood from the following description of embodiments in connection with the drawings, wherein

FIG. 1a is a flow diagram of a user resource management method provided by an embodiment of this application;

FIG. 1b is a further flow diagram of a user resource management method provided by an embodiment of this application;

FIG. 1c is a further flow diagram of a user resource management method provided by an embodiment of this application;

FIG. 2 is an expanded flow diagram of an optional implementation of a user resource management method provided by an embodiment of this application;

FIG. 3 is a partial flow diagram of another user resource management method provided by an embodiment of this application;

FIG. 4 is a partial flow diagram of still another user resource management method provided by an embodiment of this application;

FIG. 5 is a structure framework diagram of a user resource management apparatus provided by an embodiment of this application;

FIG. 6 is a structure framework diagram of another user resource management apparatus provided by an embodiment of this application;

FIG. 7 is a structure framework diagram of a customs declaration form management device provided by an embodiment of this application.

### DETAILED DESCRIPTION

In the following, this application will be described in detail, and examples of the embodiments of this application will be shown in the drawings, wherein identical or similar reference signs represent identical or similar components or components with identical or similar functions throughout. In addition, if a detailed description of a known technique is unnecessary for a shown feature of this application, it will be omitted. In the following, embodiments described with reference to the drawings are exemplary, only used for explaining this application, and cannot be construed as limiting this application.

It may be appreciated by the person having ordinary skills in the art that, all terms (comprising technical terms and scientific terms) used herein have the same meanings as the general understanding of those of ordinary skills in the art to which this application belongs, unless otherwise defined. It should also be appreciated that, those terms defined such as in general dictionaries should be understood as having meanings consistent with those in the context of the prior art, and will not be interpreted with idealized or overly formal meanings unless specifically defined as here.

It may be appreciated by the person having ordinary skills in the art that, the single forms “a”, “an”, “said” and “this” used here may also comprise plural forms, unless specifically stated. It should be further appreciated that, the word “comprise” used in the specification of this application means the existence of the feature, integer, step, operation, element and/or assembly, but does not exclude the existence or addition of one or more other feature, integer, step, operation, element, assembly, and/or a group thereof. It should be appreciated that when an element is said to be “connected” or “coupled” to another element, it may be directly connected or coupled to the other element, or also there may be an intermediated element. In addition, the “connection” or “coupling” used herein may comprise wireless connection or wireless coupling. The wording “and/or” used herein comprises all or any unit of and all combinations of one or more associated listed terms.

First, several nouns involved in the embodiments of this application will be introduced and explained.

Customs affair is a systematic project that involves a series of professional issues and policies and regulations such as customs clearance, logistics, foreign exchange, cost, taxation, as well as internal operating documents, operating procedures, and accounting methods. Therein, customs affair logistics is one link thereof, and has association with one or more other links of customs affair.

Letter of guarantee (L/G), also called guarantee, refers to a written credit guarantee certificate issued by a bank, an insurance company, a guarantee company or an individual to a third party at the request of an applicant, which is used to guarantee that when the applicant fails to perform its/his/her responsibilities or obligations in accordance with the agreement between the two parties, the guarantor shall, on its/his/her behalf, perform a certain payment or financial compensation liability within a certain amount and within a certain period of time. For convenience, in general, companies and banks have printed guarantees in a certain format, of which the functions comprise delivering goods by a letter of guarantee, issuing a clean bill of lading by a letter of guarantee, reversing an advance bill of lading by a letter of guarantee, and so on.

Deposit, also called logistics deposit, is a fund that is pre-deposited by both parties into a capital account of a website which is entrusted to monitor a transaction process, and meanwhile, is authorized to be used by the website according to the circumstances described in the “Auction Transaction Contract”, in order to ensure that both parties of a transaction fulfill their commitments in the transaction.

The letter of guarantee and the deposit are mainly applied in goods imported temporarily or with an exemption form: (1) imported temporarily: this refers to items not intended for sale, for example, cartons and pallets packaging imported goods, which will be exported and returned to the supplier after the imported materials are used up, wherein the import taxes and fees for such items may mortgage the letter of guarantee at the time of import, and the letter of guarantee may be released by way of export settlement at the time of export; (2) imported with an exemption form: if goods imported with an exemption form have arrived at the customs, but relevant certificates and materials of the exemption form have not been reviewed, the import taxes and fees may first mortgage the letter of guarantee, and the letter of guarantee may be released by way of exemption form settlement after the review of the certificates and materials of the exemption form is finished.

SAP (System Application and Products in data processing) is a kind of management software for enterprise resource planning ERP, which continuously provides comprehensive enterprise-level management software solutions to enterprises in various industries in the world through its application software, services and support. The SAP provides a complete set of business measures in a modular form, and the modules thereof include all the necessary business functions and link users with technical application software to form a comprehensive system, which is used for strategic and operational management of a company or enterprise and has the characteristics of integration and flexibility. Therefore, as the new generation of business intelligence applications represented by the SAP is widely favored by enterprise users, the number of users of the SAP in China also increases sharply accordingly.

In the following, the technical solutions of this application and how the technical solutions of this application solve the above technical problems will be described in detail by means of specific embodiments. The following several specific embodiments may be combined with each other, and identical or similar concepts or procedures may not be repeated any longer in some embodiments. The names, codes, numerical values, etc. of relevant tables used in the following embodiments are only schematic. In the following, the embodiments of this application will be described in connection with the drawings.

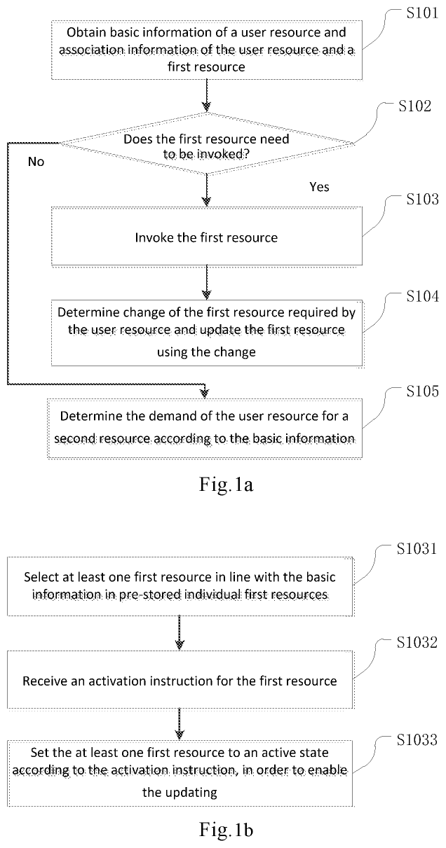

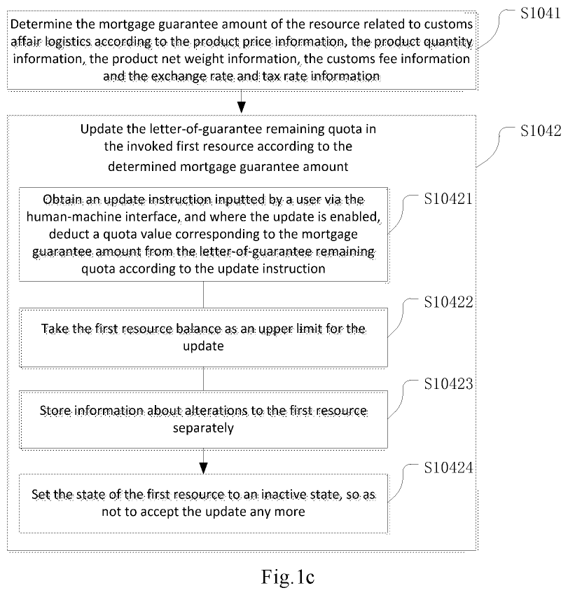

An embodiment of this application provides a user resource management method provided by execution of computer software. As shown in FIG. 1a, the management method comprises the following steps S101-S105.

At S101, basic information of a user resource and association information of the user resource and a first resource are obtained, and the obtaining may be to obtain by a human-machine interface receiving a manual input, or obtain from a network via a network interface.

In an example, the user resource comprises a resource related to customs affair logistics, for example, a resource involved in a customs declaration form, and the association information of the user resource and the first resource comprises exemption information.

In an embodiment, the basic information comprises product price information, product quantity information, product net weight information, customs fee information and exchange rate and tax rate information required for customs declaration.

In an embodiment, obtaining customs-declaration-form basic information of a customs declaration form comprises obtaining the declaration date of the customs declaration form.

At S102, it is determined whether the first resource is in need of to be invoked based on the association information, which first resource comprises a resource related to a letter of guarantee, and in the above example, this step is to determine whether the customs declaration form needs to use a letter of guarantee; and if yes, S103 is performed, otherwise, S105 is performed.

At S103, the first resource is invoked, that is, the letter of guarantee corresponding to the basic information of the customs declaration form in the above example.

In an embodiment, as shown in FIG. 1b, at step 1031, at least one first resource in line with the basic information is selected in pre-stored individual first resources; at step 1032, an activation instruction for the first resource is received; and at step 1033, the at least one first resource is set to an active state according to the activation instruction, in order to allow the updating. In the above example, that is, at least one letter of guarantee in line with the basic information of the customs declaration form is selected in individual groups of pre-stored letters of guarantee; an activation instruction for the letter of guarantee corresponding to the basic information of the customs declaration form is received; and one corresponding letter of guarantee is set to an active state according to the activation instruction.

At S104, change of the first resource required by the user resource is determined utilizing a rule-based engine according to at least part of the basic information, and the first resource is updated using the change. In the above example, that is, according to the basic information of the customs declaration form, mortgage guarantee amount and mortgage guarantee expiration date of the customs declaration form are determined and the letter of guarantee is updated.

It should be appreciated that, the rule-based engine is for example a component embedded into an application program, and most rule-based engines support implementation of rules in a simple script language, and support embedded development of a general development language. The rule-based engine realizes separation of business decision from an application program code and uses a predefined semantic module to write the business decision, the application program triggers the rule-based engine by submitting data or an object to the rule-based engine, and the rule-based engine invokes a corresponding rule and then triggers a corresponding operation. In general, a rule contains a set of rule conditions and operations performed under the rule conditions, and the rule-based engine will trigger all the operations under this rule to be performed if and only if all the rule conditions in this rule are matched successfully. In the above example, a rule between at least part of the basic information and the demand for the first resource may be set in the rule-based engine.

FIG. 1c is a further flow diagram of a user resource management method provided by an embodiment of this application. As shown in FIG. 1c, in an embodiment, at step 1041, the mortgage guarantee amount of the customs declaration form may be determined as follows. The mortgage guarantee amount of the customs declaration form is determined according to the product price information, the product quantity information, the product net weight information, the customs fee information and the exchange rate and tax rate information.

In an embodiment, the letter of guarantee may be determined as follows. At step 1042, the letter-of-guarantee remaining quota in the invoked first resource (e.g., the letter of guarantee) is updated according to the determined mortgage guarantee amount. Further, for example, at step 10421, an update instruction inputted by a user is obtained via the human-machine interface, and where the updating is allowed, a quota value corresponding to the mortgage guarantee amount is deducted from the letter-of-guarantee remaining quota according to the update instruction.

In an embodiment, at step 10422, when the first resource balance is insufficient, the first resource balance is taken as an upper limit for the update. For example, in the above example, the mortgage guarantee expiration date of the customs declaration form may be determined as follows. The mortgage guarantee expiration date of the customs declaration form is determined according to the declaration date of the customs declaration form and a preset mortgage guarantee period. As another instance, in still the above example, it is judged whether the mortgage guarantee expiration date is greater than the letter-of-guarantee expiration date in the letter of guarantee; if the mortgage guarantee expiration date is not greater than the letter-of-guarantee expiration date, the mortgage guarantee expiration date is reserved; and if the mortgage guarantee expiration date is greater than the letter-of-guarantee expiration date, then the mortgage guarantee expiration date is updated employing the letter-of-guarantee expiration date.

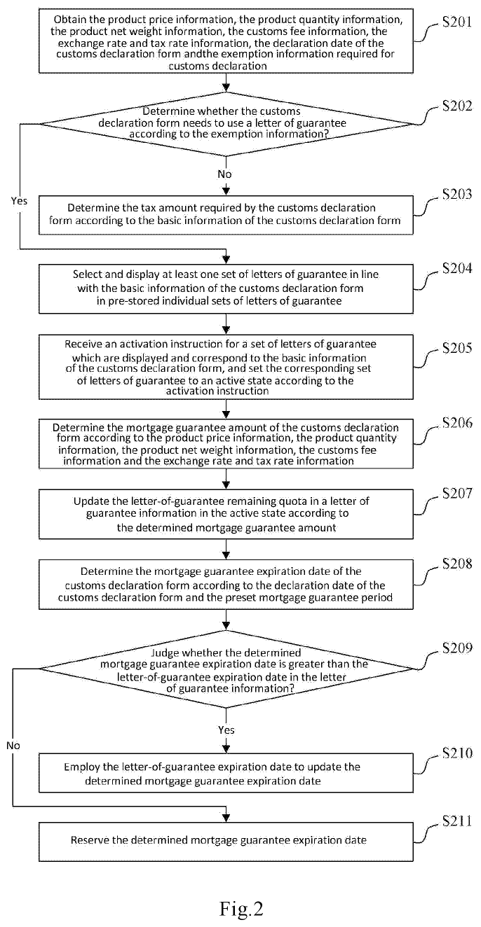

In an embodiment, at step 10423, after the update instruction inputted by the user is obtained, information about alterations to the first resource is further stored separately. This will be further described in detail in the following description in connection with FIG. 2. In an embodiment, at step 10424, after the information about alterations to the first resource is stored separately, the state of the first resource is further set to an inactive state, so as not to accept the update any more. This will be further described in detail in the following description in connection with FIG. 2. In an embodiment, when the first resource is updated using the change, the first resource will not accept other update any more.

At S105, the demand of the user resource for a second resource is determined according to the basic information. In the above example, for example, the required tax amount of the customs declaration form is determined according to the basic information of the customs declaration form.

In the following, an expanded flow of an example of the user resource management method provided by an embodiment of this application will be introduced with reference to FIG. 2.

At S201, the product price information, the product quantity information, the product net weight information, the customs fee information, the exchange rate and tax rate information, the declaration date of the customs declaration form and the exemption information required for customs declaration are obtained.

In an embodiment, the product price information, the product quantity information, the product net weight information, the customs fee information, the exchange rate and tax rate information, the declaration date of the customs declaration form and the exemption information may be information inputted by a user, wherein the product price information comprises a FOB (Free On Board) unit price, the product quantity information comprises the quantity of products declared at the customs, the product net weight information comprises individual product net weight and total product net weight, the customs fee information comprises customs freight and customs premium, the exchange rate and tax rate information comprises exchange rate, tariff rate and value-added-tax rate, and the exemption information comprises relevant information on the exemption nature of customs declaration form.

In an embodiment, it may further be possible to obtain other information of the customs declaration form, for example, product gross weight, client, freight currency system, etc., and the obtained information may be stored in a pre-created customs-declaration-form background table ZIMBGH. An example of the customs-declaration-form background table ZIMBGH is as follows.

TABLE 1

| | | | | Reserved | | |
|---|---|---|---|---|---|---|
| Technical | | Data | Output | decimal | Primary | |
| name | Field name | type | length | places | key | Note |
| MANDT | Client | CLNT | 3 | 0 | # | |
| BKNOS | Internal manual | CHAR | 6 | 0 | # | |
| | number | | | | | |
| DOCNUM | Internal customs | CHAR | 18 | 0 | # | |
| | declaration | | | | | |
| | form No. | | | | | |
| APLDAT | Declaration date | DATS | 8 | 0 | | |
| NETWGH | Net weight | QUAN | 13 | 3 | | |
| GROWGH | Gross weight | QUAN | 13 | 3 | | |
| FREIGH | Freight | CURR | 13 | 2 | | |
| F_CUR | Freight currency | CUKY | 5 | 0 | | |
| | system | | | | | |
| INSURA | Premium | CURR | 13 | 2 | | |
| IN_CUR | Premium | CUKY | 5 | 0 | | |
| | currency system | | | | | |
| BHNOS | L/G serial | CHAR | 7 | 0 | | |
| | number | | | | | |
| BCLSDAT | Mortgage | DATS | 8 | 0 | | |
| | guarantee | | | | | |
| | expiration date | | | | | |
| YBJE | Mortgage | CURR | 13 | 2 | | |
| | guarantee | | | | | |
| | amount | | | | | |

At S202, it is determined whether the customs declaration form needs to use a letter of guarantee according to the exemption information; and if yes, S204 is performed, otherwise, S203 is performed.

In particular, it is judged whether the exemption nature of the customs declaration form is in the form of a letter of guarantee according to the exemption information, and if yes, mortgage guarantee is in need of to be performed for the customs declaration form and therefore S204 is performed, otherwise, mortgage guarantee does not need to be performed for the customs declaration form and therefore S203 is performed.

At S203, the tax amount required by the customs declaration form is determined according to the basic information of the customs declaration form.

In an embodiment, the calculation method of the required tax amount is the same as that of the mortgage guarantee amount, which may refer to subsequent expressions (1) to (4), and will not be repeated here any longer.

At S204, at least one letter of guarantee in line with the basic information of the customs declaration form is selected in pre-stored individual letters of guarantee and displayed.

In an embodiment, each letter of guarantee may comprise more than one piece of information such as letter-of-guarantee No., letter-of-guarantee quota, letter-of-guarantee expiration date, transportation mode, etc., and the individual letters of guarantee may be stored in a pre-created letter-of-guarantee background table ZIMBH.

In an embodiment, a method for creating the letter-of-guarantee background table ZIMBH is as follows.

A letter-of-guarantee transaction code ZIMBH1 is created, which letter-of-guarantee transaction code ZIMBH1 may provide the functions of creating the letter-of-guarantee background table ZIMBH according to letters of guarantee that need to be stored, and adding and storing internal letter-of-guarantee Nos. serially generated by the system and required letters of guarantee in the letter-of-guarantee background table ZIMBH. At the time of storage, the letter-of-guarantee transaction code ZIMBH1 may judge whether there has stored a letter-of-guarantee background table ZIMBH with the same letter-of-guarantee Nos., and if yes, send out prompt information and prohibit saving the created letter-of-guarantee background table ZIMBH, and if no, save the created letter-of-guarantee background table ZIMBH.

In an embodiment, at least one of the following settings may be made for the saved letter-of-guarantee background table ZIMBH:

1) taking state of a letter of guarantee in the saved letter-of-guarantee background table ZIMBH as a created state by default and setting its state code to 0;

2) setting any one or more piece of field information in the saved letter-of-guarantee background table ZIMBH to be required, for example, setting the letter-of-guarantee No., the letter-of-guarantee quota, the letter-of-guarantee enabling time and the letter-of-guarantee ending time to be required;

3) setting a drop-down menu for any one or more piece of field information in the saved letter-of-guarantee background table ZIMBH, which drop-down menu is used for showing branch options for the field information, for example, a drop-down menu may be set for the transportation mode to show two branch options, water transportation and air transportation;

4) setting any one or more piece of field information with the state code of 0 in the saved letter-of-guarantee background table ZIMBH to be modifiable, and setting the other letters of guarantee to be unmodifiable; and

5) setting modifiable field information to be such that modification or deletion may be performed only for one modification or deletion instruction, thereby avoiding that multiple users modify the same filed information at the same time.

An example of the letter-of-guarantee background table ZIMBH created in the above way is as follows.

TABLE 2

| | | | | Reserved | | |
|---|---|---|---|---|---|---|
| Technical | | Data | Output | decimal | Primary | |
| name | Field name | type | length | places | key | Note |
| MANDT | Client | CLNT | 3 | 0 | # | |
| BHNOS | Internal L/G | CHAR | 7 | 0 | # | Serial code |
| | serial No. | | | | | G000001-G999999 |
| | | | | | | incremented by 1 |
| | | | | | | automatically each |
| | | | | | | time a new L/G is |
| | | | | | | created |
| BHNOC | L/G No. | CHAR | 50 | 2 | | |
| BHAMT | L/G total quota | CURR | 25 | 2 | | |
| BHAMT_SY | L/G remaining | CURR | 25 | 2 | | |
| | quota | | | | | |
| BHSDT | L/G enabling | DATS | 10 | 0 | | |
| | time | | | | | |
| BHEDT | L/G expiration | DATS | 10 | 0 | | |
| | time | | | | | |
| PSDAT | Business | DATS | 10 | 0 | | Date on which the |
| | starting time | | | | | L/G state is |
| | | | | | | changed to |
| | | | | | | “active”. |
| PEDAT | Business | DATS | 10 | 0 | | Date on which the |
| | ending time | | | | | L/G state is |
| | | | | | | changed to |
| | | | | | | “closed”. |
| TNTOOL | Transportation | CHAR | 2 | 0 | | There are only two |
| | mode | | | | | values, “water |
| | | | | | | transportation” |
| | | | | | | and “air |
| | | | | | | transportation”, |
| | | | | | | the code of the |
| | | | | | | former is 1, and |
| | | | | | | the code of the |
| | | | | | | latter is 2. |
| PSTUD | L/G state | CHAR | 1 | 0 | | There are three |
| | | | | | | states in total, |
| | | | | | | “created (0)”, |
| | | | | | | “active (1)” and |
| | | | | | | “closed (2)”, the |
| | | | | | | state can only be |
| | | | | | | changed in an |
| | | | | | | order of 0→1→2, |
| | | | | | | and the order is |
| | | | | | | irreversible. |
| DMARK | Deletion mark | CHAR | 1 | 0 | | A mark X is |
| | | | | | | marked after |
| | | | | | | deletion. |
| ERNAM | User name | CHAR | 12 | 0 | | Create/modify the |
| | | | | | | user name of the |
| | | | | | | L/G |
| ERDAT | Date | DATS | 10 | 0 | | Last modified date |

In an embodiment, for a letter of guarantee in the letter-of-guarantee background table ZIMBH as shown in Table 2, a modification or deletion operation may be performed on it, of which an embodiment is as follows.

creating a modification or deletion transaction code ZIMBH2 for the letter-of-guarantee background table ZIMBH, which modification or deletion transaction code ZIMBH2 may provide a function of modifying modifiable field information or deleting any specified field information after receiving an instruction of modification or deletion.

In an embodiment, when displaying at least one set of selected letters of guarantee, the table structure and content in at least one corresponding letter-of-guarantee background table ZIMBH may be displayed.

In an embodiment, an alteration operation such as modification, deletion, update, etc. may be performed on a letter of guarantee in Table 2 according to the actual situation, and the change of a numerical value in the letter-of-guarantee background table after the alteration is stored in a pre-created letter-of-guarantee alteration log table ZIMBH_H. An example of the letter-of-guarantee alteration log table ZIMBH_H is as follows.

TABLE 3

| | | | | Reserved | | |
|---|---|---|---|---|---|---|
| Technical | | Data | Output | decimal | Primary | |
| name | Field name | type | length | places | key | Note |
| MANDT | Client | CLNT | 3 | 0 | # | |
| BHNOS | Internal L/G | CHAR | 7 | 0 | # | |
| | serial No. | | | | | |
| POSNR | L/G No. | NUMC | 6 | 0 | # | |
| BHAMT | L/G total | CURR | 13 | 2 | | L/G total quota after |
| | quota | | | | | modification |
| BHAMT_SY | L/G remaining | CURR | 13 | 2 | | L/G remaining quota |
| | quota | | | | | after modification |
| BHSDT | L/G enabling | DATS | 8 | 0 | | L/G enabling time |
| | time | | | | | after modification |
| BHEDT | L/G ending | DATS | 8 | 0 | | L/G ending time after |
| | time | | | | | modification |
| PSDAT | Business | DATS | 8 | 0 | | Business starting time |
| | starting time | | | | | after modification |
| PEDAT | Business | DATS | 8 | 0 | | Business ending time |
| | ending time | | | | | after modification |
| TNTOOL | Transportation | CHAR | 2 | 0 | | Transportation mode |
| | mode code | | | | | code after |
| | (L/G) | | | | | modification |
| PSTUD | L/G state | CHAR | 1 | 0 | | L/G state after |
| | | | | | | modification |
| DMARK | Deletion mark | CHAR | 1 | 0 | | Deletion mark after |
| | | | | | | modification |
| BHAMT_O | L/G total | CURR | 13 | 2 | | L/G total quota before |
| | quota | | | | | modification |
| BHAMT_SY_O | L/G remaining | CURR | 13 | 2 | | L/G remaining quota |
| | quota | | | | | before modification |
| BHSDT_O | L/G enabling | DATS | 8 | 0 | | L/G enabling time |
| | time | | | | | before modification |
| BHEDT_O | L/G ending | DATS | 8 | 0 | | L/G ending time |
| | time | | | | | before modification |
| PSDAT_O | Business | DATS | 8 | 0 | | Business starting time |
| | starting time | | | | | before modification |
| PEDAT_O | Business | DATS | 8 | 0 | | Business ending time |
| | ending time | | | | | before modification |
| TNTOOL_O | Transportation | CHAR | 2 | 0 | | Transportation mode |
| | mode code | | | | | code before |
| | (L/G) | | | | | modification |
| PSTUD_O | L/G state | CHAR | 1 | 0 | | L/G state before |
| | | | | | | modification |
| DMARK_O | Deletion mark | CHAR | 1 | 0 | | Deletion mark before |
| | | | | | | modification |
| TCODE | Business | CHAR | 20 | 0 | | Transaction code used |
| | operation TC | | | | | in modification |
| DOCNUM | Import | CHAR | 18 | 0 | | No. of involved |
| | declaration | | | | | mortgage guarantee |
| | No. | | | | | customs declaration |
| | | | | | | form |
| UPNAM | Person who made | CHAR | 12 | 0 | | |
| | the last | | | | | |
| | alteration | | | | | |
| UDAT | Altered on | DATS | 8 | 0 | | |

At S205, an activation instruction for a set of letters of guarantee which are displayed and correspond to the basic information of the customs declaration form is received, and the corresponding set of letters of guarantee is set to an active state according to the activation instruction.

When a letter of guarantee is activated and in the active state, a mortgage guarantee operation may be performed on the letter of guarantee, for example, the L/G remaining quota is updated according to the mortgage guarantee amount of the customs declaration form.

In an embodiment, the received activation instruction comprises L/G No., the state code of the active state may be set to 1, and that the corresponding set of letters of guarantee is set to an active state according to the activation instruction may specifically comprise: setting the state code of a set of letters of guarantee corresponding to the L/G No. to 1 according to the activation instruction.

Through the above steps S204 and S205, it may be possible to realize automatic screening of letters of guarantee and automatic activation of a letter of guarantee based on the activation instruction, to cause it to be in an invokable state, and there is no manual successive search and activation, which increases the activation efficiency.

At S206, the mortgage guarantee amount of the customs declaration form is determined according to the product price information, the product quantity information, the product net weight information, the customs fee information and the exchange rate and tax rate information.

In an embodiment, duty-paid price is determined according to the FOB unit price, the quantity of products declared at the customs, the individual product net weight, the total product net weight, the customs freight, the customs premium, the exchange rate and tax rate (comprising the tariff rate and the value-added-tax rate). A specific calculation method is as follows:

Duty-paid price=(FOB unit price×quantity×exchange rate+individual net weight/total net weight×customs freight×exchange rate)/(1−1.1×customs premium) (1)

Further, the tariff and the value added tax are determined according to the obtained tariff rate, value-added-tax rate and the duty-paid price determined based on the expression (1). A specific calculation method is as follows:

Tariff=duty-paid price×tariff rate (2)

Value added tax=(duty-paid price+tariff)×value-added-tax rate (3)

Further, the mortgage guarantee amount of the customs declaration form is determined according to the tariff determined based on the expression (2) and the value added tax determined based on the expression (3). A specific calculation method is as follows:

Mortgage guarantee amount=theoretical tariff+theoretical value added tax (4)

In an embodiment, the determined mortgage guarantee amount is stored at a corresponding position of the customs-declaration-form background table ZIMBGH, or the numerical value of the determined mortgage guarantee amount is employed to update the numerical value of the mortgage guarantee amount of the customs-declaration-form background table ZIMBGH.

The embodiments of this application may realize automatic calculation of the mortgage guarantee amount based on the above individual expressions without the need of manual calculation, which greatly increases the calculation efficiency.

At S207, the letter-of-guarantee remaining quota of a letter of guarantee in the active state is updated according to the determined mortgage guarantee amount.

In an embodiment, an update instruction inputted by the user is obtained, and a quota value corresponding to the mortgage guarantee amount is deducted from the letter-of-guarantee remaining quota according to the update instruction. In an example, the update instruction may be a settlement instruction inputted by the user.

In an embodiment, before a quota value corresponding to the mortgage guarantee amount is deducted from the letter-of-guarantee remaining quota according to the update instruction, there may further be comprised: judging whether the determined mortgage guarantee amount is greater than the letter-of-guarantee remaining quota of the set of letters of guarantee in the active state, and if yes, generating and displaying error information, and if no, deducting a quota value corresponding to the mortgage guarantee amount from the letter-of-guarantee quota of the set of letters of guarantee in the active state, to implement update of the value of the letter-of-guarantee remaining quota and in turn implement update of a letter of guarantee.

If the value of the letter-of-guarantee remaining quota of the updated letter of guarantee is greater than 0, it may indicate that the letter of guarantee may be applied in a next mortgage guarantee operation, and if the value of the letter-of-guarantee remaining quota after the update is 0 or a numerical value less than 0, it indicates that the letter of guarantee cannot be applied in a next mortgage guarantee operation.

In an embodiment, the update operation of the letter-of-guarantee remaining quota of the set of letters of guarantee in the active state is stored separately, and recorded in the letter-of-guarantee alteration log table ZIMBH_H.

In an embodiment, after the letter-of-guarantee remaining quota of a letter of guarantee in the active state is updated, the letter of guarantee is converted from the active state to the inactive state. In particular, the state code of the inactive state may be set to 2, and after the letter-of-guarantee remaining quota of the letter of guarantee in the active state is updated, the state code of the letter of guarantee is modified from 1 to 2, so as not to accept update any more.

At S208, the mortgage guarantee expiration date of the customs declaration form is determined according to the declaration date of the customs declaration form and the preset mortgage guarantee period.

In an embodiment, a specific calculation method for the mortgage guarantee expiration date of the customs declaration form is mortgage guarantee expiration date=declaration date+mortgage guarantee period, wherein the mortgage guarantee period may be set according to the actual situation, for example, set according to the customs policy in practice. In general, the mortgage guarantee period set by the customs is 6 months, and when the customs policy is adjusted, the specific numerical value of the mortgage guarantee period will be adjusted accordingly.

The embodiments of this application may realize automatic calculation of the mortgage guarantee expiration date by the above calculation method without the need of manual calculation, which increases the calculation efficiency.

At S209, it is judged whether the determined mortgage guarantee expiration date is greater than the letter-of-guarantee expiration date in the letter of guarantee; and if yes, S210 is performed, and if no, S211 is performed.

At S210, the letter-of-guarantee expiration date is employed to update the determined mortgage guarantee expiration date.

When the determined mortgage guarantee expiration date is greater than the letter-of-guarantee expiration date, since the mortgage guarantee time limit exceeds the normal usage time limit of the invoked letter of guarantee, the letter of guarantee cannot be normally used to perform the mortgage guarantee operation, which will thereby result in failure of mortgage guarantee. Therefore, it is necessary to adjust the mortgage guarantee expiration date by the step S210 to improve the accuracy of the mortgage guarantee expiration date and reduce the failure of mortgage guarantee.

In an embodiment, the letter-of-guarantee expiration date is taken as a new mortgage guarantee expiration date to replace the determined mortgage guarantee expiration date and the mortgage guarantee expiration date after the replacement is displayed.

At S211, the determined mortgage guarantee expiration date is reserved.

When the determined mortgage guarantee expiration date is not greater than the letter-of-guarantee expiration date, the invoked letter of guarantee may be normally used to perform the mortgage guarantee operation, and therefore, the determined mortgage guarantee expiration date may be reserved and displayed.

In an optional embodiment, after obtaining the settlement instruction inputted by the user as the update instruction, the user resource management method provided by the embodiment of this application further comprises: saving the basic information of the customs declaration form, the determined mortgage guarantee amount and mortgage guarantee expiration date and the updated letter of guarantee, and generating and saving settlement information based on the basic information of the customs declaration form, the mortgage guarantee amount and the mortgage guarantee expiration date, or updating pre-stored settlement information, according to the settlement instruction.

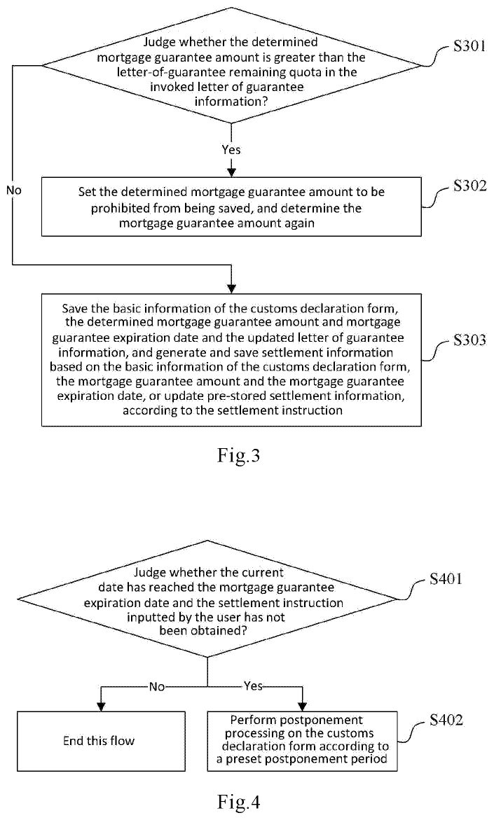

In another optional embodiment, as shown in FIG. 3, after obtaining the settlement instruction inputted by the user as the update instruction, the user resource management method provided by the embodiment of this application further comprises the following steps S301-S303.

At S301, it is judged whether the determined mortgage guarantee amount is greater than the letter-of-guarantee remaining quota of the invoked letter of guarantee; and if yes, S302 is performed, and if no, S303 is performed.

At S302, the determined mortgage guarantee amount is set to be prohibited from being saved, and the mortgage guarantee amount is determined again.

The way of determining the mortgage guarantee amount again is the same as the way of determining the mortgage guarantee amount described above and will not be repeated here any longer.

At S303, the basic information of the customs declaration form, the determined mortgage guarantee amount and mortgage guarantee expiration date and the updated letter of guarantee are saved, and settlement information based on the basic information of the customs declaration form, the mortgage guarantee amount and the mortgage guarantee expiration date is generated and saved, or pre-stored settlement information is updated, according to the settlement instruction.

In an embodiment, the settlement information generated based on the basic information of the customs declaration form, the mortgage guarantee amount and the mortgage guarantee expiration date comprises the settlement completion date. It may be appreciated by the person having ordinary skills in the art that, the settlement information may further comprise information such as submitted form No., settlement handling date, settlement mode, user name, etc., which will not be listed one by one here any longer.

In an embodiment, a letter-of-guarantee settlement background table ZIMBHJA that is pre-created for this mortgage guarantee operation is queried, and it is judged whether information on the letter-of-guarantee settlement identification in the letter-of-guarantee settlement background table ZIMBHJA is empty. If the information on the letter-of-guarantee settlement identification is empty, a letter-of-guarantee settlement identification is added according to the current update progress of the letter-of-guarantee remaining quota. For example, when the update of the letter-of-guarantee remaining quota has been finished, the letter-of-guarantee settlement identification is added. The letter-of-guarantee settlement identification may be represented by any character, for example “X”. When the update of the letter-of-guarantee remaining quota has not been finished, the letter-of-guarantee remaining quota continues to be updated, and the letter-of-guarantee settlement identification is added after the update is finished.

If the information on the letter-of-guarantee settlement identification is not empty, it is further judged whether information on the settlement completion date is empty. If the information on the settlement completion date is empty, the generated settlement completion date is stored in the letter-of-guarantee settlement background table ZIMBHJA. If the information on the settlement completion date is not empty, it is judged whether the settlement completion date is correct, and if no, the settlement completion date in the letter-of-guarantee settlement background table ZIMBHJA is updated, and if yes, it indicates that this mortgage guarantee operation has been settled.

In an embodiment, when the settlement information comprises information such as submitted form No., settlement handling date, settlement mode, user name, etc., it may be similarly judged whether relevant information in the letter-of-guarantee settlement background table ZIMBHJA is empty, and corresponding settlement information is stored when it is empty.

In an embodiment, a way of storing information of the letter-of-guarantee settlement background table ZIMBHJA is as follows:

creating a letter-of-guarantee settlement transaction code ZIMBH6, which letter-of-guarantee postponement transaction code is used for uploading and storing corresponding settlement information in the pre-created letter-of-guarantee settlement background table ZIMBHJA.

In an embodiment, a structural example of the letter-of-guarantee settlement background table ZIMBHJA is as follows.

TABLE 4

| | | | | Reserved | | |
|---|---|---|---|---|---|---|
| Technical | | Data | Output | decimal | Primary | |
| name | Field name | type | length | places | key | Note |
| MANDT | Client | CLNT | 3 | 0 | # | |
| BKNOS | Internal manual | CHAR | 6 | 0 | # | |
| | number | | | | | |
| DOCNUM | Internal customs | CHAR | 18 | 0 | # | |
| | declaration form No. | | | | | |
| DECLNO | Customs declaration | CHAR | 20 | 0 | | |
| | form No. | | | | | |
| JAFS | Settlement mode | CHAR | 7 | 0 | | Form exemption/ |
| | | | | | | export/taxation |
| JAJJDAT | Settlement document | DATS | 10 | 0 | | |
| | handover date | | | | | |
| BLJADAT | Settlement handling | CHAR | 7 | 0 | | |
| | date | | | | | |
| JAWCDAT | Settlement completion | DATS | 10 | 0 | | |
| | date | | | | | |
| DMARK | Deletion mark | CHAR | 1 | 0 | | |
| ERNAM | User name | CHAR | 12 | 0 | | |
| ERDAT | Date | DATS | 10 | 0 | | |
| UZEIT | Time | TIMS | 8 | 0 | | |
| ZJABZ | L/G settlement | CHAR | 1 | 0 | | |
| | identification | | | | | |

In an optional embodiment, as shown in FIG. 4, on the basis of the above steps S101 to S104 or on the basis of the above steps S201 to S211, the user resource management method provided by the embodiments of this application may further comprise the following steps S401 and S402:

S401, judging whether the current date has reached the mortgage guarantee expiration date and the settlement instruction inputted by the user has not been obtained, and if yes, S402 is performed, and if no, the flow is ended;

S402, performing postponement processing on the customs declaration form according to a preset postponement period.

When the current date has reached the mortgage guarantee expiration date and the settlement instruction inputted by the user has not been obtained, it is considered that the mortgage guarantee operation for the customs declaration form has not finished currently and postponement is necessary, and therefore, postponement processing is performed on the customs declaration form by the step S402.

In an embodiment, the postponement expiration date is determined according to the preset postponement period. In particular, the mortgage guarantee expiration date and the postponement period are summed, and the obtained date is just the postponement expiration date.

The postponement period may be set according to the actual situation, for example, set according to the customs policy in practice. In general, the postponement period set by the customs is the same as the mortgage guarantee period and is 6 months, and when the customs policy is adjusted, the specific numerical value of the postponement period will be adjusted accordingly.

In an embodiment, after the postponement expiration date is determined, the mortgage guarantee expiration date recorded in the customs-declaration-form background table is updated to be the postponement expiration date, and the number of postponement times for this postponement is determined according to the postponement information in a pre-created letter-of-guarantee background postponement table ZIMBHYQ. In particular, it is queried whether information on the number of postponement times exists in the letter-of-guarantee background postponement table ZIMBHYQ, and if yes, the number of postponement times for this postponement is determined according to the existing information on the number of postponement times. For example, if the number of postponement times existing in the letter-of-guarantee background postponement table ZIMBHYQ is 0, it is determined that the number of postponement times for this postponement is 1 (representing the first postponement); if the number of postponement times existing in the letter-of-guarantee background postponement table ZIMBHYQ is 1, it is determined that the number of postponement times for this postponement is 2 (representing the second postponement); and so on. If no, that is, the information on the number of postponement times in the letter-of-guarantee background postponement table ZIMBHYQ is empty, it is directly determined that the number of postponement times for this time is 1.

In an embodiment, after the postponement expiration date is determined and the mortgage guarantee expiration date recorded in the customs-declaration-form background table is updated to be the postponement expiration date, it is judged whether the updated mortgage guarantee expiration date is greater than the letter-of-guarantee expiration date in the invoked letter of guarantee, and if yes, another set of letters of guarantee is invoked for mortgage guarantee (the method is similar to the invocation method described above and will not be repeated any more), thereby implementing postponement in different letters of guarantee, and if no, the set of letters of guarantee which is in the active state currently continues to be invoked for mortgage guarantee, thereby implementing postponement in the same letter(s) of guarantee.

In an embodiment, corresponding information in the customs-declaration-form background table ZIMBGH and the letter-of-guarantee background table ZIMBH is updated according to the postponement expiration date and/or the letter-of-guarantee No. (or also called letter-of-guarantee serial No.) of the newly invoked letter of guarantee. In particular, the mortgage guarantee expiration date stored in the customs-declaration-form background table ZIMBGH is updated to be the determined postponement expiration date, the letter-of-guarantee No. stored in the customs-declaration-form background table ZIMBGH is updated to be that of the newly invoked letter of guarantee, the quota value of the letter-of-guarantee remaining quota stored in the letter-of-guarantee background table ZIMBH corresponding to the original letter of guarantee is increased, the increased quota value is equal to the mortgage guarantee amount, the quota value of the letter-of-guarantee remaining quota stored in the letter-of-guarantee background table ZIMBH corresponding to the newly invoked letter of guarantee is decreased, and the decreased quota value is equal to the mortgage guarantee amount.

In an embodiment, the update operation or modification operation of the letter-of-guarantee background table ZIMBH is stored in the letter-of-guarantee alteration log table ZIMBH_H.

In an embodiment, relevant information (e.g., at least one of the postponement expiration date, the number of postponement times, the letter-of-guarantee No. of the invoked letter of guarantee, the letter-of-guarantee No. of the original letter of guarantee, etc.) on the postponement processing operation of the customs declaration form is stored in the pre-created letter-of-guarantee background postponement table ZIMBHYQ. Therein, the relevant information on the postponement processing operation of the customs declaration form comprises at least one of the postponement expiration date, the number of postponement times, the letter-of-guarantee No. of the invoked letter of guarantee, the letter-of-guarantee No. of the original letter of guarantee, etc. In particular, it is queried whether the relevant information on the postponement processing operation has existed at a corresponding position of the pre-created letter-of-guarantee background postponement table ZIMBHYQ, and if the relevant information on the postponement processing operation has existed, the existing information is reserved, and if information has existed but is different from the relevant information on the postponement processing operation, the existing information is updated to be the relevant information on the postponement processing operation.

In an embodiment, a method for storing information of the letter-of-guarantee background postponement table ZIMBHYQ is as follows:

creating a letter-of-guarantee postponement transaction code ZIMBH5 which is used for uploading and storing the relevant information on the postponement processing operation in the pre-created letter-of-guarantee background postponement table ZIMBHYQ.

In an embodiment, a structural example of the letter-of-guarantee background postponement table ZIMBHYQ is as follows.

TABLE 5

| | | | | Reserved | |
|---|---|---|---|---|---|
| Technical | | Data | Output | decimal | Primary |
| name | Field name | type | length | places | key |
| MANDT | Client | CLNT | 3 | 0 | # |
| BKNOS | Internal manual | CHAR | 6 | 0 | # |
| | number | | | | |
| DOCNUM | Internal customs | CHAR | 18 | 0 | # |
| | declaration form | | | | |
| | No. | | | | |
| YQNUM | Number of | CHAR | 1 | 0 | # |
| | postponement | | | | |
| | times | | | | |
| DECLNO | Customs | CHAR | 20 | 0 | |
| | declaration | | | | |
| | form No. | | | | |
| BHNOS1 | Original L/G | CHAR | 7 | 0 | |
| | internal No. | | | | |
| BHNOS2 | New L/G | CHAR | 7 | 0 | |
| | internal No. | | | | |
| BHEDT | Postponement | DATS | 10 | 0 | |
| | expiration date | | | | |
| DMARK | Deletion mark | CHAR | 1 | 0 | |
| ERNAM | User name | CHAR | 12 | 0 | |
| ERDAT | Date | DATS | 10 | 0 | |

In an embodiment, an upper limit value of the number of postponement times in the background postponement table ZIMBHYQ shown in Table 4 may be set according to the actual situation. For example, one and the same mortgage guarantee operation can only be postponed for 3 times according to the current customs policy, and then the upper limit value of the number of postponement times in the background postponement table ZIMBHYQ may be set to 3. When the number of postponement times determined in this postponement processing procedure is 4, the number of postponement times is considered invalid and will not be used for updating the numerical value of the number of postponement times in the background postponement table ZIMBHYQ.

Application of the user resource management method provided by the embodiments of this application may achieve at least the following beneficial effects.

It may be possible to automatically determine whether it is necessary to invoke a first resource based on the obtained basic information of a user resource and the association information of the user resource and the first resource, and when it is necessary to invoke the first resource, a rule-based engine can be utilized to determine change of the first resource required by the user resource, and the first resource is updated using the change. Thus, it may be possible to implement orderly and effective operation, deployment and update of resources.

In an example, in particular, the following beneficial effects may be achieved.

1) The embodiments of this application may automatically determine whether a letter of guarantee is in need of to be used for a customs declaration form based on obtained basic information of the customs declaration form and exemption information, automatically invoke a corresponding letter of guarantee when it is necessary to use a letter of guarantee, and automatically calculate the mortgage guarantee amount and the mortgage guarantee expiration date of the customs declaration form and update the letter of guarantee, and thereby may implement automatic management of the customs declaration form, which increases the efficiency of customs declaration form management, reduces the consumption of human resources, reduces the management cost, and at the same time also effectively avoids the problem that an error happens easily in manual management, improves the accuracy of customs declaration form management, and is more in line with user management needs.

2) The embodiments of this application may automatically calculate the required tax amount of the customs declaration form when it is unnecessary to use a letter of guarantee, which meets the basic general needs for the customs declaration form in a case in which it is unnecessary to use a letter of guarantee, increases the efficiency of customs declaration form management, reduces the consumption of human resources, reduces the management cost, and at the same time also effectively avoids the problem that an error happens easily in manual management, and improves the accuracy of customs declaration form management.

3) The embodiments of this application may automatically insure the letter-of-guarantee remaining quota according to the determined mortgage guarantee amount, to implement update of the letter-of-guarantee remaining quota, and may increase the update efficiency of the letter-of-guarantee remaining quota; and the deducted quota value is in line with the mortgage guarantee amount, which improves the update accuracy of the letter-of-guarantee remaining quota.

4) The embodiments of this application may automatically perform settlement processing on the customs declaration form by updating the letter-of-guarantee remaining quota, saving the basic information of the customs declaration form, the mortgage guarantee amount, the mortgage guarantee expiration date and the updated letter of guarantee, and so on, whereas manual settlement needs a complex flow, and thereby the settlement efficiency may be increased.

5) The embodiments of this application may automatically perform postponement processing on the customs declaration form and determine the postponement expiration date when the mortgage guarantee expiration date has been reached but a settlement instruction has not been obtained currently, may automatically replace the letter of guarantee when the postponement expiration date is greater than the letter-of-guarantee expiration date, and thereby may ensure the effectiveness and continuity of the customs-declaration-form mortgage guarantee business and reduce unnecessary business interruptions.

Based on the same inventive concept, an embodiment of this application provides a user resource management apparatus which may perform the user resource management method provided in the method embodiments described above. As shown in FIG. 5, the user resource management apparatus 500 comprises: a data obtainer 501, a condition judger 502, an invoker 503 and an updater 504.

The data obtainer 501 is configured to obtain basic information of a user resource and association information of the user resource and a first resource via a human-machine interface or a network interface, and is used for obtaining customs-declaration-form basic information and exemption information of a customs declaration form.

The condition judger 502 is configured to determine whether the first resource is in need of to be invoked based on the association information; and is used for determining whether a letter of guarantee is in need of to be used according to the exemption information.

The invoker 503 is configured to invoke the first resource in response to determination of the need.

The updater 504 is configured to determine change of the first resource required by the user resource utilizing a rule-based engine according to at least part of the basic information, and update the first resource using the change.

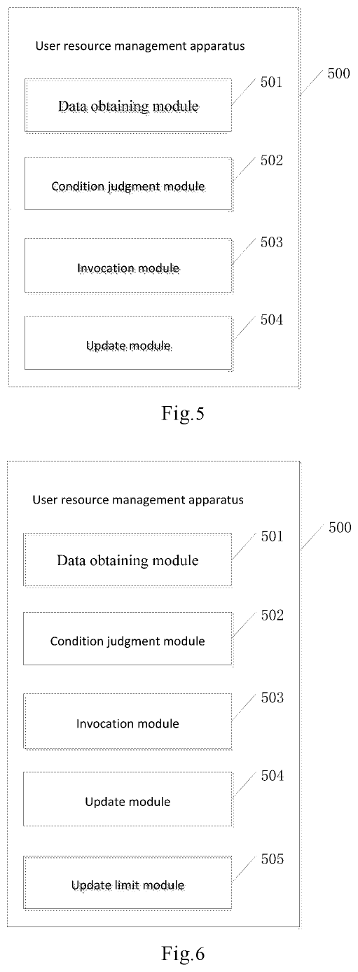

In an embodiment, as shown in FIG. 6, the user resource management apparatus provided by an embodiment of this application further comprises: an update limiter 505 configured to determine the first resource balance as an upper limit for the update when the first resource balance is insufficient.

In an embodiment, the invoker 503 is further configured to perform the steps 1031-1033 described above with reference to FIG. 1b.

In an embodiment, the updater 504 is further configured to the steps 1041-1042 described above with reference to FIG. 1c.

In an embodiment, the user resource management apparatus 500 provided by an embodiment of this application may be arranged in a SAP system.

The user resource management apparatus 500 provided by the embodiments of this application has the same inventive concept and the same beneficial effects as the method embodiments described above, and the content of the user resource management apparatus 500 which is not shown in detail may refer to the method embodiments described above and will not be repeated here any longer.

In the above embodiments, for convenience of understanding and description, in partial paragraphs, description of functions uses a way of describing functional modules corresponding to functions to be performed by a processor. For example, with reference to the description of FIG. 5 and FIG. 6, it is easily understood that these modules are functional entities, and do not necessarily have to correspond to physically or logically independent entities. The processor may implement these functional entities by running software to execute computer instructions, or programmably implement these functional entities in one or more hardware module or integrated circuit. In general, these modules comprise routines, programs, objects, elements, components, data structures, etc. performing specific tasks or implementing specific abstract data types. The terms “module”, “function” and “component” used herein generally represent software, firmware, hardware or a combination thereof. Although a certain number and type of modules have been described above, it may be appreciated that other numbers and/or types and/or structures may be included according to the individual embodiments. Therefore, according to a desired implementation, it may further be possible to further divide a module function and/or combine it with other module functions.

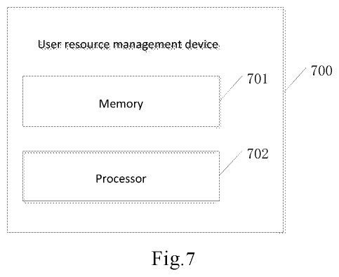

Based on the same inventive concept, an embodiment of this application provides a user resource management device. As shown in FIG. 7, the user resource management device 700 comprises: a memory 701 and a processor 702.

On the memory 701 in the embodiment of this application is stored a computer program, which computer program is executed by the processor 702 to implement the user resource management method provided by the embodiments of this application.

The memory 701 in the embodiment of this application may be a ROM (read-only memory) or a static storage device of other type capable of storing static information and instructions, may be a RAM (random access memory) or a dynamic storage device of other type capable of storing information and instructions, or also may be an EEPROM (electrically erasable programmable read only memory), CD-ROM (compact disc read only memory) or other optical disk storage, optical disc storage (comprising compressed disc, laser disc, optical disk, digital universal disc, blu-ray disc, etc.), magnetic disk storage medium or other magnetic storage device, or any other medium capable of being used for carrying or storing a desired program code in the form of instructions or data structures and capable of being accessed by a computer, but is not limited thereto.

The processor 702 in the embodiment of this application may be a CPU (central processing unit), a general purpose processor, a DSP (digital signal processor), an ASIC (application specific integrated circuit), an FPGA (field programmable gate array) or other programmable logic device, transistor logic device, hardware component or any combination thereof. It may implement or perform various exemplary logic blocks, modules and circuits described in connection with the disclosure of this application. The processor 702 may also be a combination implementing the calculation function, for example, a combination comprising one or more microprocessor, a combination of a DSP and a microprocessor, or the like.

It may be appreciated by the person having ordinary skills in the art that, the user resource management device 700 provided by the embodiment of this application may be specially designed and manufactured for a required purpose, or also may comprise known devices in a general purpose computer. These devices have computer programs stored therein, and these computer programs are selectively activated or reconstructed. Such computer programs may be stored in a device- (e.g., computer-) readable medium or stored in any type of media adapted for storing electronic instructions and coupling to a bus, respectively.

The user resource management device 700 provided by the embodiment of this application has the same inventive concept and the same beneficial effects as the various embodiments described above, and the content of the user resource management device 700 which is not shown in detail may refer to the various embodiments described above and will not be repeated here any longer.

Based on the same inventive concept, an embodiment of this application provides a computer readable storage medium storing a computer program thereon, which computer program, when executed by a processor, implements the user resource management method provided by the embodiments of this application.

The computer readable storage medium comprises, but is not limited to, any type of disk (comprising a floppy disk, a hard disk, an optical disk, a CD-ROM, and a magneto-optical disk), ROM, RAM, EPROM (erasable programmable read-only memory), EEPROM, flash memory, magnetic card or light card. That is, the readable medium comprises any medium that storing or transmitting information by a device (e.g., a computer) in a readable form.

Based on the same inventive concept, an embodiment of this application provides a computer program product storing a computer program thereon, which computer program, when executed by a processor, implements the user resource management method provided by the embodiments of this application.

The computer readable storage medium and the computer program product provided by the embodiments of this application have the same inventive concept and the same beneficial effects as the various embodiments described above, and the content of the computer readable storage medium and the computer program product which is not shown in detail may refer to the various embodiments described above and will not be repeated here any longer.

It may be appreciated by the person having ordinary skills in the art that, the steps, measures, schemes in the various operations, methods and flows in this application which have been discussed may be alternated, altered, combined or deleted. Further, other steps, measures, schemes having the various operations, methods and flows in this application which have been discussed may also be alternated, altered, rearranged, decomposed, combined or deleted. Further, steps, measures, schemes in the prior art having the various operations, methods and flows disclosed in this application may also be alternated, altered, rearranged, decomposed, combined or deleted.

It may be appreciated that, although the various steps in the flow charts in the drawings are shown successively following the indication of the arrows, these steps are not necessarily performed successively in an order indicated by the arrows. Unless stated clearly herein, there is no strict order limitation to the performance of these steps, and they may be performed in other order. Moreover, at least part of the steps in the flow charts in the drawings may comprise multiple sub-steps or multiple stages. These sub-steps or stages are not necessarily completed at the same moment, but may be performed at different moments. Their performance order is also not necessarily successive, but they may be performed in turn or alternately with at least part of other steps or sub-steps or stages of other steps.

Features of the techniques described herein are independent of the platform, which means that the techniques may be embodied on various computing platforms having various processors.

What is described above is just part of the implementations of this application. It should be pointed out that, for the person having ordinary skills in the art, several improvements and modifications may further be made without departing from the principles of this application, and these improvements and modifications should also be construed as the protection scope of this application.

1. A user resource management method provided by a computer executing software, the method comprising:
obtaining basic information of a user resource and association information of the user resource and a first resource via a human-machine interface or a network interface;
determining whether the first resource is in need of to be invoked based on the association information;
invoking the first resource in response to determination of the need; and
determining change of the first resource required by the user resource utilizing a rule-based engine according to at least part of the basic information, and updating the first resource using the change.

2. The method as claimed in claim 1, further comprising:
determining demand of the user resource for a second resource according to the basic information, in response to determination of no need.

3. The method as claimed in claim 1, wherein the invoking the first resource comprises:
selecting at least one first resource in line with the basic information in pre-stored individual first resources;
receiving an activation instruction for the first resource; and
setting the at least one first resource to an active state according to the activation instruction, in order to allow the updating.

4. The method as claimed in claim 2, wherein the first resource comprises a resource related to a letter of guarantee, the association information of the user resource and the first resource comprises exemption information, and the second resource comprises taxable amount.

5. The method as claimed in claim 4, wherein
the user resource comprises a resource related to customs affair logistics, the basic information comprises:
product price information, product quantity information, product net weight information, customs fee information and exchange rate and tax rate information required for customs declaration; and
the determining change of the first resource required by the user resource utilizing a rule-based engine according to at least part of the basic information comprises:
determining the mortgage guarantee amount of the resource related to customs affair logistics according to the product price information, the product quantity information, the product net weight information, the customs fee information and the exchange rate and tax rate information.

6. The method as claimed in claim 5, wherein the updating the first resource using the change comprises:
updating letter-of-guarantee remaining quota of the invoked first resource according to the determined mortgage guarantee amount.

7. The method as claimed in claim 6, wherein the updating the letter-of-guarantee remaining quota of the invoked first resource according to the determined mortgage guarantee amount comprises:
obtaining an update instruction inputted by a user via the human-machine interface, and where the update is allowed, deducting a quota value corresponding to the mortgage guarantee amount from the letter-of-guarantee remaining quota according to the update instruction.

8. The method as claimed in claim 7, after the obtaining an update instruction inputted by a user, further comprising:
storing information about alterations to the first resource separately.

9. The method as claimed in claim 8, after the storing information about alterations to the first resource separately, further comprising:
setting the state of the first resource to an inactive state, so as not to allow the updating any more.

10. The method as claimed in claim 1, wherein when the first resource is updated using the change, the first resource will not accept other updating any more.

11. The method as claimed in claim 9, wherein the updating the first resource using the change further comprises:
when the first resource balance is insufficient, determining the first resource balance as an upper limit for the update.

12. A user resource management apparatus comprising:
a data obtainer configured to obtain basic information of a user resource and association information of the user resource and a first resource via a human-machine interface or a network interface;
a condition judger configured to determine whether the first resource is in need of to be invoked based on the association information;
an invoker configured to invoke the first resource in response to determination of the need; and
an updater configured to determine change of the first resource required by the user resource utilizing a rule-based engine according to at least part of the basic information, and update the first resource using the change.

13. The management apparatus as claimed in claim 12, further comprising:
an update limiter configured to determine the first resource balance as an upper limit for the update when the first resource balance is insufficient.

14. A user resource management device comprising: a memory and a processor, wherein in the memory is stored a computer program which is executed by the processor to implement the user resource management method as claimed in claim 1.

15. A computer readable storage medium on which a computer program is stored, which computer program implements the user resource management method as claimed in claim 1 when executed by a processor.

16. A user resource management device comprising: a memory and a processor, wherein in the memory is stored a computer program which is executed by the processor to implement the user resource management method as claimed in claim 2.

17. A user resource management device comprising: a memory and a processor, wherein in the memory is stored a computer program which is executed by the processor to implement the user resource management method as claimed in claim 3.

18. A user resource management device comprising: a memory and a processor, wherein in the memory is stored a computer program which is executed by the processor to implement the user resource management method as claimed in claim 4.

19. A user resource management device comprising: a memory and a processor, wherein in the memory is stored a computer program which is executed by the processor to implement the user resource management method as claimed in claim 5.

20. A user resource management device comprising: a memory and a processor, wherein in the memory is stored a computer program which is executed by the processor to implement the user resource management method as claimed in claim 6.
